(19) United States
(12) Patent Application Publication
(10) Pub. No.: US 2007/0106943 A1
(43) Pub. Date: May 10, 2007

(54) Operating element for an injection molding machine

(75) Inventor: Carl Schiffer, Neustadt (DE)

Correspondence Address: Thomas E. Kocovsky, Jr.;FAY, SHARPE, FAGAN, MINNICH & McKEE, LLP, Seventh Floor, 1100 Superior Avenue, Cleveland, OH, 44114-2579, US

(73) Assignee: Dr. Boy GmbH & Co. KG

(21) Appl. No.: 11/592,878

(22) Filed: Nov. 3, 2006

(30) Foreign Application Priority Data
Nov. 4, 2005 (DE) DE102005052725.6

(51) Int. Cl. G06F 3/00; G06F 17/00; G06F 9/00

(52) U.S. Cl. 715/733

(57) ABSTRACT

An operating element for an injection molding machine comprises a monitor screen (10) for visual representation of program data. Over the monitor screen (10), a touch screen (12) is fitted for performing input functions according to the screen representation. Further provided is at least one function key field (14,16,18) flanking the monitor screen (10) and function keys (20). The function keys (20) are not provided as press-on keys which would have to be cabled separately, but are integrated into the touch screen (12). For this purpose, the touch screen (12), for forming the at least one function key field (14,16,18), laterally projects the monitor screen (10).

The present invention relates to an operating element for an injection molding machine.

### BACKGROUND OF THE INVENTION

In injection molding machines, the functional processes as well as the injection molding conditions are computer-controlled. For the production of a new molded part in mass production, a new setting of the injection molding machine will have to be performed. In doing so, inter allia, also data and parameters for the production process will be stored. If modern operating elements have been installed, the setting of the injection molding machine is carried out via a monitor screen having a touch screen fitted over it. On the monitor, the program data as well as corresponding fields or buttons are visually represented. With the aid of the touch screen, the program data can be selected and/or changed. The provision of a touch screen eliminates the need for a keyboard and/or a mouse. On the monitor screen, variable keys, menus, on/off switches, listboxes and the like can be displayed. Thus, the touch screen is particularly suited for the inputting of desired values to be used in controlling the injection molding machine.

Further, flanking the screen, function keys are provided. These function keys can be arranged laterally of the screen or above or below it. Function keys are switches with a fixed key assignment. They can be provided e.g. as sensor keys. In this case, each individual key is wired. Each individual key has a function assigned to it. Particularly, these function keys are machine movement keys by which, for instance, the closing side can be moved in order to open and close the injection molds. Further, by actuating the corresponding function key, the ejector can be moved irrespective of the program data. This may be required so as to be able to correct disturbances during the production process, e.g. the jamming of an injection-molded part. Further examples of function keys include movement keys for core pullers, operating mode selection keys, movement keys for the plastifying unit, movement keys for the worm, actuating keys for the heater, actuating keys for the pump, movement keys for the ejector as well as movement keys for the closing unit, etc.

A disadvantage of these key fields flanking the screen and comprising individual function keys resides in that the function keys must be wired individually. This is bothersome and expensive. Further, such function keys will considerably wear out in operation, with a resulting impairment of their functional capability.

It is an object of the invention to provide an improved operating element for an injection molding machine which is offers good user convenience.

### SUMMARY OF THE INVENTION

According to the invention, the touch screen arranged in front of the monitor screen is configured to laterally project beyond the monitor screen at least on one side. Thus, the outer dimensions of the monitor screen are smaller than the outer dimensions of the touch screen. According to the invention, the part of the touch screen projecting beyond the monitor screen has arranged therein a key field with function keys. Since no monitor screen is arranged behind that portion of the touch screen which forms the at least one field of function keys, what is provided here is not the conventional function of a touch screen wherein the individual buttons are realized by representations on the monitor screen. Instead, the individual function keys are realized by representations on or at the touch screen. In this arrangement, the function keys are preferably provided as permanent representations. For instance, the function keys can be printed, engraved etc. as graphic symbols on the reverse side of the touch screen. The corresponding region of the touch screen which forms the field of function keys is thus provided with a fixed key assignment corresponding to the wired keys according to the state of the art which are provided e.g. as sensor keys.

By the provision of at least one field of function keys by a part of the touch screen projecting beyond the monitor screen, a wiring of the individual function keys can be completely omitted. This allows for a considerable cost reduction. Further, touch screen keys will suffer less wear under production conditions, resulting in an improved functioning capability.

Preferably, flanking the monitor screen, a plurality of fields of function keys is provided. Fields of function keys are provided particularly on the left side and the right-hand side of the monitor screen and below the monitor screen. Thus, the touch screen extends beyond the monitor screen on the left side, the right side and the lower side of the monitor screen. Of course, the option exists to arrange a further field of keys on the upper side of the monitor screen. For instance, a conventional 12″ monitor screen can be combined with a 15″ touch screen, wherein the touch screen is located in such a manner on the front face of the monitor screen that a left-hand field of function keys, a right-hand field of function keys and a lower field of function keys are formed. Besides, the provision of a 12″ monitor screen in combination with a 15″ touch screen represents an inexpensive variant of the operating element because the 12″ monitor screen is a standard product. The projecting arrangement of the touch screen, i.e. the smaller size of the monitor screen surface relative to the surface of the touch screen, may allow for a further cost reduction because no monitor screen is provided behind the projecting region of the touch screen.

According to a particularly preferred embodiment of the invention, the individual function keys are realized by a design film. Represented on this design film are individual graphic symbols depicting the functions of the individual keys. It is also possible to additionally assign a comprehensive symbol to a whole group of function keys. For instance, a group of function keys can be related to the worm drive so that a symbol of the worm drive is represented to the side of this group of function keys and the function keys are marked e.g. by arrows pointing to the left and the right, respectively. In this manner, the function of the worm drive is visualized.

To avoid damage to the design film, it is preferred that the design film is glued or printed onto the rear side of the touch screen.

According to a particularly preferred embodiment of the invention, at least a part of the function keys are connected to an optical display means for status indication. This display means can be provided as an LED display corresponding to the state of the art. Preferably, the optical indication of the status is displayed via the screen. In this case, preferably, each of the individual function keys—and preferably all of them—have assigned thereto a portion of the screen where the status of the corresponding function is indicated. With particular preference, this screen portion is provided in the marginal region in direct proximity to the corresponding function key. The optical indication of the status can be presented as a green or red dot similar to an LED representation.

A preferred embodiment of the invention will be described in greater detail hereunder with reference to the accompanying drawings.

### BRIEF DESCRIPTION OF THE DRAWINGS

FIG. 1 is a plan view illustrating a preferred embodiment of the operating element;

FIG. 2 is a schematic plan view of the operating element in simplified representation; and

FIG. 3 is a schematic lateral view taken in the direction of arrow III in FIG. 2.

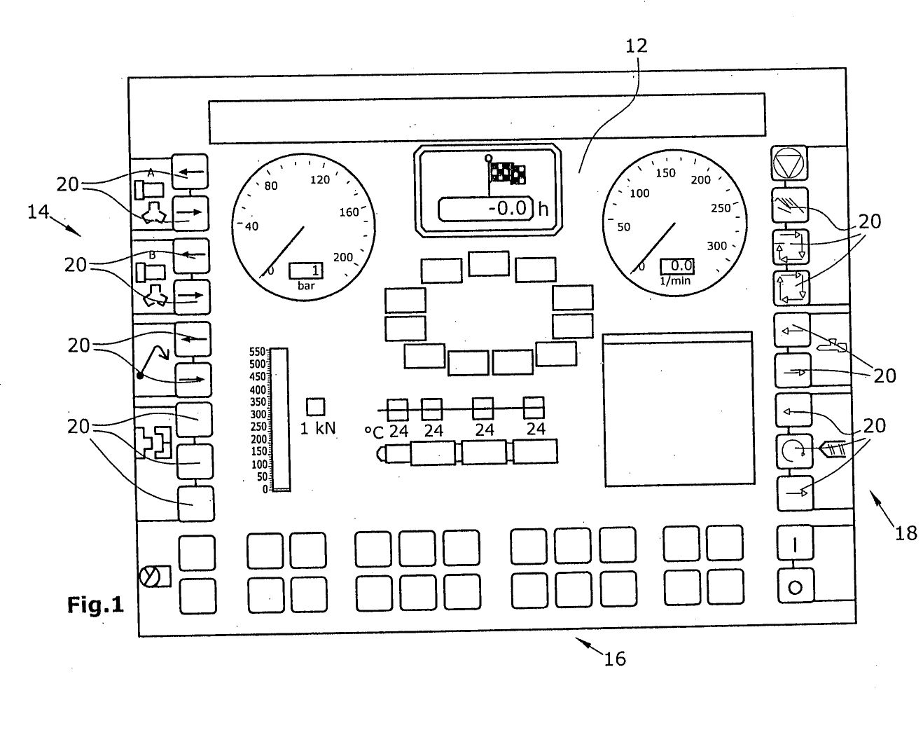

### DETAILED DESCRIPTION OF A PREFERRED EMBODIMENT

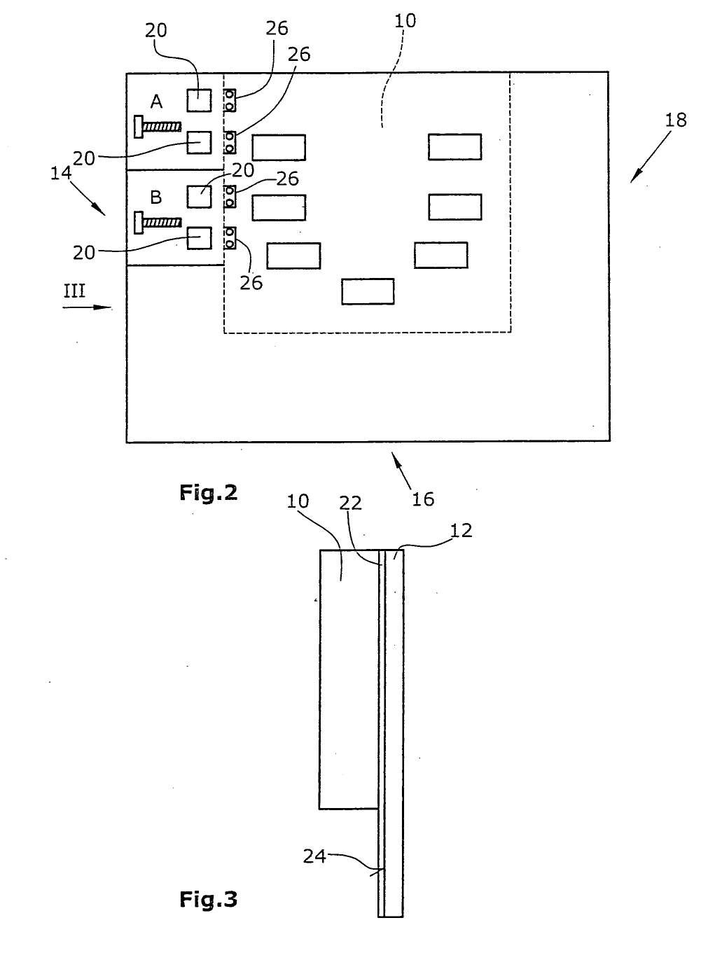

The operating element of the invention comprises a monitor screen, particularly a flat screen 10. Provided in a position in front of the monitor screen, as seen from the viewer's perspective, is a touch screen 12. In the illustrated embodiment, the touch screen 12 projects beyond the monitor screen 10 on the left-hand side and on the right-hand side as well as on the lower side (FIG. 2). The portions of touch screen 12 projecting beyond monitor screen 10 form three fields 14,16,18 of function keys. Among these fields, for instance, the function key fields 14 and 18 can be machine operating keys. Function key field 16 may particularly include side selection keys. In the lower left corner of function key fields 14 and 16, there can further be provided an actuation key for the pump, and on the lower right-hand side between function key fields 16 and 18 an actuating key for the heating can be provided. Within the individual function key fields, function keys 20 are arranged. The function keys 20 are realized in that, within the individual function key fields 14,16,18, i.e. in those portions of touch screen 12 which project beyond the monitor screen 10, a design film 22 (FIG. 3) is arranged on—e.g. glued to—the rear side 24 of the touch screen.

By the provision of the design film 22, permanent visual representations are assigned to each function key 20. Thus, by touching the touch screen 12 in the region of the pre-assigned keys, a pre-assigned function such as e.g. the actuation of the ejector, is performed. Since, according to the invention, the key assignment of the function keys 20 has been fixedly predetermined and is not, as in conventional touch screens, performed via monitor screen arranged behind the touch screen, a changing of the function of individual keys is not provided.

At least a part of the function keys 20, and preferably all of them, have assigned thereto an optical status display 26. The optical status display is realized by monitor screen 10 or a dedicated partial region of monitor screen 10. The optical status display is operative to indicate the status of the machine component selected by actuating the function key 20. The display is particularly performed by display of an e.g. green, yellow or red dot, with each color symbolizing a corresponding status. Thus, according to the invention, the status display is performed by the screen. This offers the advantage that, because individual LEDs are provided, no wiring is required for this purpose.

The status displays 26 are each assigned to a special function key 20 and are arranged preferably in the immediate vicinity of the function keys 20 in the peripheral region of monitor screen 10.

Via the region of touch screen 12 extending beyond monitor screen 10, the conventional functions of a touch screen combined with a monitor screen can be carried out. Particularly, symbols 28 serving as buttons are represented on the screen. By touching the touch screen at the corresponding site, individual functions, subprograms, menus etc. can be called up. Since the monitor screen is connected to a computer, particularly an industrial computer, it is possible, in dependence on the software used, to represent various programs on the screen and to select any one of them by touching the touch screen at the corresponding site. Particularly, for visual display via the monitor screen, use is made of a special software for injection molding machines, such as e.g. the software “Visu4WINners” of Resotec GmbH, Baunatal. By means of this software, the visual representations on the monitor screen and on the associated portion of the touch screen, respectively, as well as the user operation of these screens can be freely designed.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. An operating element for an injection molding machine, comprising:
a monitor screen for visual representation of program data,
a touch screen fitted over the monitor screen and provided for program selection according to the screen representation, and
at least one function key field flanking the monitor screen and including pre-assigned function keys,
wherein,
for forming said at least one function key field, the touch screen laterally projects beyond the monitor screen.

2. The operating element according to claim 1 wherein the function keys of the function key field are provided as permanent representations on the touch screen.

3. The operating element according to claim 1 wherein the function keys are formed as a design film.

4. The operating element according to claim 1 wherein the representations of the function keys are provided on a rear side of a portion of the touch screen projecting beyond the monitor screen.

5. The operating element according to claim 1 wherein at least a part of the function keys are coupled to an optical display for status indication.

6. The operating element according to claim 5 wherein the optical display for status indication is implemented in the monitor screen, particularly in the peripheral region of the monitor screen in the immediate vicinity of the corresponding function key.

7. A display and input apparatus for a molding machine, comprising:
a video monitor;
a translucent touch screen mounted to a display screen of the video monitor such that a display on the display screen is visible through the touch screen, the touch screen being larger than the display screen such that a portion of the touch screen extends beyond the display screen;
representation of function keys permanently marked on the portion of the touch screen that extends beyond the display screen such that functions can be selected touching corresponding marked function keys.

8. The display and input apparatus according to claim 7, further including:
indicator lights mounted behind a rear face of the portion of the touch screen that extends beyond the display screen adjacent the marked function keys for indicating a status of corresponding functions.
